(19) United States
(12) Patent Application Publication
(10) Pub. No.: US 2026/0341764 A1
(43) Pub. Date: Oct. 29, 2026

(54) HIGH EFFICIENCY MODULAR FUEL CELL SYSTEM

(71) Applicant: HNPOWER INC., Daejeon (KR)

(72) Inventors: In Yong Kang, Daejeon (KR); Jin Woo Park, Daejeon (KR); Byeong Chang Kim, Daejeon (KR); Seung Jun Kim, Daejeon (KR)

(21) Appl. No.: 19/159,559

(22) PCT Filed: Jul. 22, 2024
(86) PCT No.: PCT/KR2024/010533

§ 371 Date: Aug. 25, 2025

(30) Foreign Application Priority Data
Jul. 20, 2023 (KR) 10-2023-0094462

(51) Int. Cl. H01M 8/0606

(52) U.S. Cl. CPC H01M 8/0606

(57) ABSTRACT

The present disclosure discloses a high-efficiency modular fuel cell system including a fuel cell stack, a reformer integrated with a burner, configured to directly utilize heat generated from the burner to reform external fuel into hydrogen; and a plurality of heat exchangers configured to receive burner off-gas from the reformer via a hot line and continuously process the burner off-gas, wherein the reformer and the plurality of heat exchangers are modularized in a space adjacent to the fuel cell stack.

### TECHNICAL FIELD

The present invention relates to a high-efficiency modular fuel cell system. More specifically, the present invention relates to a high-efficiency modular fuel cell system that maximizes thermal efficiency by arranging a continuously configured heat exchanger module and a fuel cell stack module as a single system.

### BACKGROUND ART

Conventional Solid Oxide Fuel Cells (hereinafter, SOFCs) are power generation systems that convert electrical energy and thermal energy by reforming solid oxides at high temperatures through catalytic reactions to produce electricity.

The structure of the SOFC consists of a cold end that supplies an energy source, a hot box that reforms the supplied energy source at high temperatures, a stack that converts the reformed solid fuel into electrical energy, and an inverter that draws and supplies power.

However, there is a need for the development of new system technology that maximizes thermal efficiency by considering the heat duty of the heat exchangers in the stack and hot box.

### DISCLOSURE OF THE INVENTION

### Technical Problem

An object of the present invention is to provide a new fuel cell system that maximizes thermal efficiency.

### Technical Solution

To solve the above problem, the present invention provides a high-efficiency modular fuel cell system comprising: a fuel cell stack; a reformer integrated with a burner to directly utilize heat generated from the burner, reforming external fuel into hydrogen; and a plurality of heat exchangers that receive burner off-gas from the reformer via a hot line and continuously process it, wherein the reformer and the heat exchangers are modularized in a space adjacent to the fuel cell stack.

In one embodiment of the present invention, the heat exchangers include a first heat exchanger, a second heat exchanger, a third heat exchanger, and a fourth heat exchanger, and the burner off-gas sequentially passes through the first heat exchanger, the second heat exchanger, the third heat exchanger, and the fourth heat exchanger, exchanging heat via a hot line.

In one embodiment of the present invention, air supplied to a cathode of the fuel cell stack sequentially passes through the fourth heat exchanger and the first heat exchanger, exchanging heat via a cold line.

In one embodiment of the present invention, the high-efficiency modular fuel cell system further includes an eighth heat exchanger between the first heat exchanger and the fourth heat exchanger, wherein the eighth heat exchanger receives anode off-gas from the anode of the fuel cell stack via a hot line, and heats the air that has passed through the fourth heat exchanger before it enters the first heat exchanger.

In one embodiment of the present invention, the burner heats the reformer and simultaneously generates the burner off-gas to heat the cathode of the fuel cell stack.

In one embodiment of the present invention, air and fuel are supplied to the burner, wherein a portion of the air is pre-mixed with the fuel entering the burner, and the remaining portion of the air is supplied to a side of the burner.

In one embodiment of the present invention, the remaining portion of the air is introduced into a middle side of a burner chamber, thereby controlling the height of the burner flame.

### Advantageous Effects

According to the present invention, a fuel cell with high thermal efficiency can be implemented by sequentially connecting each off-gas to a heat exchanger and modularizing the hot box. Furthermore, by integrating the burner and the reforming reaction, burner off-gas can be utilized from the initial stage of operation, allowing for the simultaneous heating of the reformer and the fuel cell. Additionally, by configuring the air inlet line supplied to the burner integrated with the reformer to the side of the burner, the height of the flame at the bottom of the reformer can be effectively controlled.

### BRIEF DESCRIPTION OF THE DRAWINGS

FIG. 1 is a block diagram of a fuel cell system according to an embodiment of the present invention.

FIG. 2 is a process flow diagram of a fuel cell system according to an embodiment of the present invention.

FIG. 3 is a diagram illustrating a process of heating air supplied to a cathode according to an embodiment of the present invention.

FIG. 4 is a schematic cross-sectional view of a burner in a fuel cell system according to an embodiment of the present invention.

FIG. 5 is a perspective view of a burner according to an embodiment of the present invention.

### BEST MODE FOR CARRYING OUT THE INVENTION

Hereinafter, preferred embodiments of the present invention will be described in detail with reference to the accompanying drawings.

Before describing the present invention in detail, it should be understood that terms or words used in this specification should not be interpreted as being unconditionally limited to ordinary or dictionary meanings, and the inventor of the present invention may appropriately define and use concepts of various terms to describe his or her invention in the best possible way.

Furthermore, it should be understood that these terms or words should be interpreted as meanings and concepts consistent with the technical spirit of the present invention.

That is, the terms used in this specification are only for describing preferred embodiments of the present invention and are not intended to specifically limit the content of the present invention.

It should be understood that these terms are defined considering various possibilities of the present invention.

In addition, in this specification, a singular expression may include a plural expression unless the context clearly indicates otherwise.

Also, similarly, even if expressed in plural, it should be understood that it may include a singular meaning.

Throughout this specification, when a component is described as “comprising” another component, it may mean that it may further include any other components, unless there is a specific description to the contrary that excludes any other components.

Furthermore, when a component is described as “being present within or connected to” another component, it may mean that this component may be directly connected to or in contact with another component.

In this specification, “hot line” refers to a line connected to a heat exchanger that supplies heat through a medium, and “cold line” refers to a line connected to a heat exchanger through which a medium flows that is heated by receiving heat from the medium of the hot line. In this specification, while “hot line” and “cold line” are used for brevity, they are understood to refer more specifically to a “hot fluid line” and a “cold fluid line,” respectively, indicating conduits through which heated or cooled fluids flow in connection with the heat exchanger.

To solve the above problem, the present invention provides a high-efficiency modular fuel cell system comprising: a fuel cell stack; a reformer integrated with a burner that directly utilizes heat generated from the burner to reform external fuel into hydrogen; and a heat exchanger system including a plurality of heat exchangers that receive burner off-gas from the reformer via a hot line and continuously process it.

In particular, the present invention has an adjacent structure in a single system where the stack and the hot box (reformer and heat exchangers) are separate modules. In this specification, “module” refers to a unit system directly within a distinguishable space (e.g., a plate) within a single system, and “adjacent” means that each module is arranged side-by-side or vertically relative to each other.

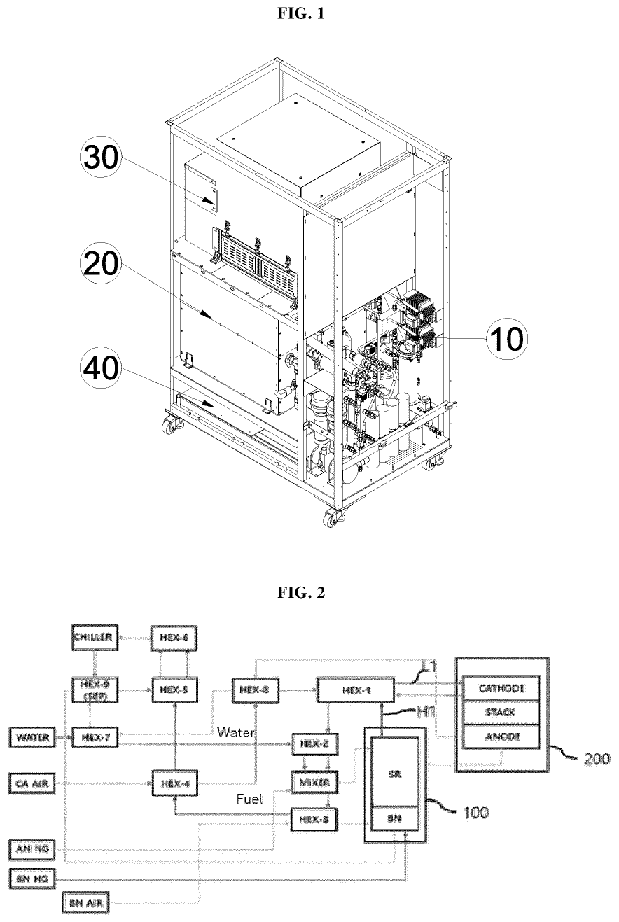

FIG. 1 is a block diagram of a fuel cell system according to an embodiment of the present invention.

Referring to FIG. 1, a fuel cell system according to an embodiment of the present invention includes a Cold Box 10 configured as a device for supplying solid oxide fuel; a Hot Box 20 that converts fuel supplied from the Cold Box into thermal energy; a Stack 30 that receives raw materials reformed and heated from the Hot Box to produce power; and an Inverter 40 that transmits and transfers the produced power.

The present invention particularly modularizes the stack and hot box in distinct spaces within a single system and installs them adjacently. This arrangement maximizes thermal efficiency by minimizing heat exchange lines and offers advantages in ease of maintenance and management.

In one embodiment of the present invention, the hot box includes a reformer combined with a burner and a plurality of serially connected heat exchangers. In particular, in one embodiment of the present invention, the burner integrated with the reformer performs the function of heating the air supplied to the stack while providing the necessary heat for the reforming reaction of the reformer, which will be described in more detail below.

FIG. 2 is a process flow diagram of a fuel cell system according to an embodiment of the present invention.

Referring to FIG. 2, the fuel cell system according to the present invention includes a reformer 100 in which a burner (BN) and a reforming reactor (SR) are integrated, and a fuel cell stack unit 200 that receives hydrogen from the reformer to produce power. The fuel cell includes a cathode and an anode.

The present invention also includes a first heat exchanger (HEX-1) that receives off-gas generated from the burner (hereinafter, Burner Off-Gas (BOG)) via a hot line, and a second heat exchanger (HEX-2), a third heat exchanger (HEX-3), and a fourth heat exchanger (HEX-4) serially connected to the first heat exchanger (HEX-1).

That is, the BOG generated after the ignition of the burner integrated with the reforming reactor sequentially passes through the first heat exchanger, the second heat exchanger, the third heat exchanger, and the fourth heat exchanger via a hot line, gradually cooling down.

The present invention particularly focuses on heating the air supplied to the cathode to a high temperature immediately before its use. It connects the first heat exchanger, which receives the highest temperature BOG via a hot line (H1), to the air injection line (L1) directly before the cathode, thereby supplying air heated to the highest temperature to the cathode of the fuel cell.

Subsequently, for the steam generation of water, which requires the second highest heat load, the present invention supplies water to the second heat exchanger (HEX2) connected to the first heat exchanger to generate steam. The present invention also includes a mixer (MIXER) for mixing steam and fuel, where the steam heated and generated in the second heat exchanger and the fuel are mixed and supplied to the reformer 100.

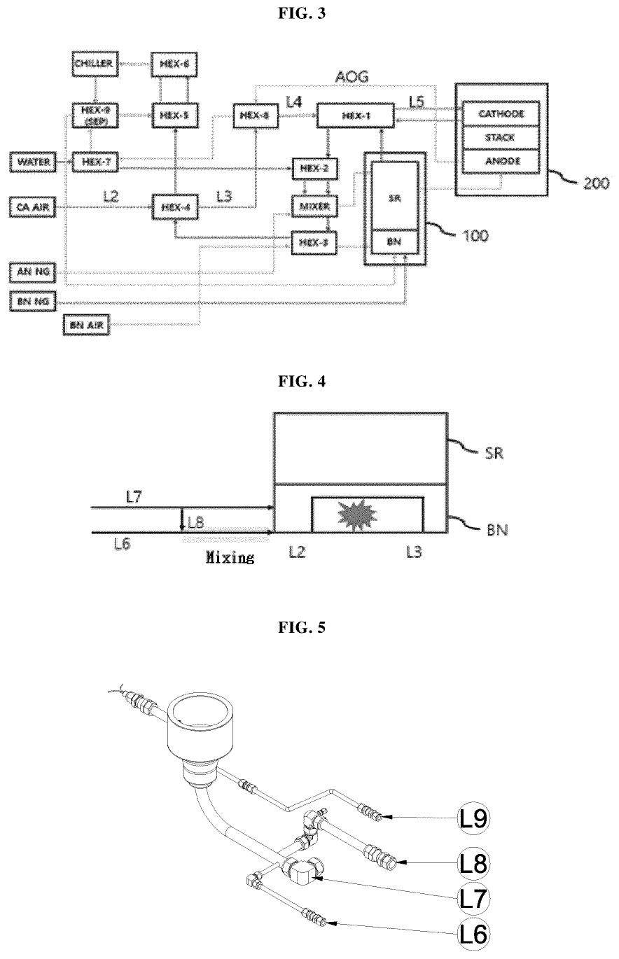

FIG. 3 is a diagram illustrating the process of heating air supplied to a cathode according to an embodiment of the present invention.

Referring to FIG. 3, the air heated in the first heat exchanger (HEX-1) and supplied to the cathode via line L5 is initially heated in the fourth heat exchanger (HEX-4) downstream of the BOG hot line before entering the cathode from the first heat exchanger (HEX-1). That is, the BOG that has passed through the third heat exchanger (HEX-3) in the BOG line first heats the external air in the fourth heat exchanger. Subsequently, the initially heated air passes through line (L3) to the eighth heat exchanger (HEX-8) for a second heating, and then is finally heated a third time in the first heat exchanger (HEX-1). That is, while passing through L2-L3-L4-L5, the air undergoes first, second, and third heating processes. Depending on the heat load, the air is secondarily heated in the eighth heat exchanger by anode off-gas (AOG) coming from the stack unit 200, considering the actual air heating temperature conditions and the heat loads of each BOG and AOG.

Therefore, the present invention utilizes these multiple heat exchangers arranged in series to sequentially multi-stage heat air and water using anode off-gas and burner off-gas. In particular, the modular configuration minimizes the length of lines between unit modules, resulting in very high thermal efficiency.

As described above, the fuel cell system according to the present invention integrates the reforming reactor and the burner. By supplying fuel and air to the burner, the burner provides the heat for the reforming reaction while simultaneously heating the fuel cell with the generated burner off-gas (refer to the first heat exchanger in FIG. 2).

Therefore, burner operation is very important in the present invention. The present invention pre-mixes a portion of the supplied air with fuel outside the burner and supplies the remaining portion to the side of the burner to stably maintain the flame generated after ignition. Hereinafter, the burner according to the present invention will be described in more detail with reference to the drawings.

FIG. 4 is a schematic cross-sectional view of a burner in a fuel cell system according to an embodiment of the present invention.

Referring to FIG. 4, the reformer 100 according to an embodiment of the present invention includes a reactor (SR) equipped with a catalyst in its upper part, and a burner (BN) in its lower part that receives fuel such as natural gas and air, ignites them, and generates heat.

The present invention particularly confirmed that the position of the flame generated after ignition is very important in the reforming reaction under a reformer system where a separate reforming reactor is provided in the upper part. To this end, a second air supply line (L8) branched from a first air supply line (L7) is connected to a fuel supply line (L6) to pre-mix fuel and air before they are supplied to the burner.

Furthermore, in the present invention, another third air supply line (L9) branched from the first air supply line (L7) is connected to the middle side of the burner. In this case, the air supplied from the third air supply line (L9) performs the function of suppressing the flame generated in the torch part (not shown) within the burner from rising upwards, thereby enabling stable control of the flame position at the bottom of the reformer.

FIG. 5 is a perspective view of a burner according to an embodiment of the present invention.

Referring to FIG. 5, it can be seen that the burner according to an embodiment of the present invention is connected to L6 (fuel supply line, CH4 supply), L7 (combustion air supply line, air supply), L8 (recovered reformate gas line, AOG recovery), and L9 (combustion flame suppression air supply line, air supply).

As described above, the fuel cell system according to the present invention has high thermal efficiency by sequentially connecting each off-gas to the heat exchanger and modularizing the hot box. Additionally, by integrating the burner and the reforming reaction, burner off-gas can be utilized from the initial stage of operation, enabling simultaneous heating of the reformer and the fuel cell. Furthermore, by configuring the air inlet line supplied to the burner integrated with the reformer to the side of the burner, the height of the flame at the bottom of the reformer can be effectively controlled.

### INDUSTRIAL APPLICABILITY

The high-efficiency modular fuel cell system according to the present invention has industrial applicability in the fuel cell industry.

1. A high-efficiency modular fuel cell system, comprising:
a fuel cell stack;
a reformer integrated with a burner, configured to directly utilize heat generated from the burner to reform external fuel into hydrogen; and
a plurality of heat exchangers configured to receive burner off-gas from the reformer via a hot line and continuously process the burner off-gas, wherein the reformer and the plurality of heat exchangers are modularized in a space adjacent to the fuel cell stack.

2. The high-efficiency modular fuel cell system of claim 1, wherein the plurality of heat exchangers comprises a first heat exchanger, a second heat exchanger, a third heat exchanger, and a fourth heat exchanger, and the burner off-gas sequentially passes through the first heat exchanger, the second heat exchanger, the third heat exchanger, and the fourth heat exchanger, performing heat exchange via a hot line.

3. The high-efficiency modular fuel cell system of claim 2, wherein air supplied to a cathode of the fuel cell stack sequentially passes through the fourth heat exchanger and the first heat exchanger, performing heat exchange via a cold line.

4. The high-efficiency modular fuel cell system of claim 3, further comprising an eighth heat exchanger between the first heat exchanger and the fourth heat exchanger, wherein the eighth heat exchanger receives anode off-gas from an anode of the fuel cell stack via a hot line, and heats the air that has passed through the fourth heat exchanger before it enters the first heat exchanger.

5. The high-efficiency modular fuel cell system of claim 4, wherein the burner heats the reformer and simultaneously generates the burner off-gas to heat the cathode of the fuel cell stack.

6. The high-efficiency modular fuel cell system of claim 1, wherein air and fuel are supplied to the burner, a portion of the air is pre-mixed with the fuel entering the burner, and a remaining portion of the air is supplied to a side of the burner.

7. The high-efficiency modular fuel cell system of claim 6, wherein the remaining portion of the air is introduced into a middle side of a burner chamber, thereby controlling a height of a flame of the burner.
